(19) United States
(12) Patent Application Publication
(10) Pub. No.: US 2002/0104012 A1
(43) Pub. Date: Aug. 1, 2002

(54) Security token and acess point networking

(75) Inventor: Thomas G. Xydis, Manitou Beach, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Ensure Technologies, Inc.

(21) Appl. No.: 09/997,299

(22) Filed: Nov. 29, 2001

Related U.S. Application Data
(60) Provisional application No. 60/250,293, filed on Nov. 29, 2000.

(51) Int. Cl. H04Q 1/00; G05B 19/00

(52) U.S. Cl. 713/200; 340/5.6

(57) ABSTRACT

The method of the subject invention includes the steps of transmitting a radio frequency (RF) signal from a first electronic device (18) and detecting the RF signal (48) from the first electronic device (18) with an access point (20). The method also includes transmitting a RF signal (50) from a second electronic device (12) and detecting the RF signal (50) from the second electronic device (12) with the same access point (20). The method is characterized by enabling the first electronic device (18) to allow the user (16) having the second electronic device (12) to access the network (13) and the first electronic device (18) in response to the access point (20) detecting the RF signals (48, 50) from both the first (18) and the second electronic devices (12). The method further includes steps of measuring a signal strength for the RF signal (48, 50) from both the first (18) and the second electronic devices (12), comparing the signal strengths to a predetermined threshold, enabling the first electronic device (18) in response to both of the signal strengths being above the predetermined threshold.

### RELATED APPLICATIONS

This application claims priority to provisional patent application No. 60/250,293 which was filed Nov. 29, 2000.

### BACKGROUND OF THE INVENTION

1. Field of the Invention

A method of securing access to a network, the network including at least one first electronic device and at least one access point, from a user having a second electronic device.

2. Description of the Related Art

The related art provides a method of securing access to a network including at least one first electronic device and at least one access point from a user having a second electronic device. The method includes the steps of transmitting a radio frequency (RF) signal from the second electronic device, detecting the RF signal from the second electronic device with the access point and enabling the first electronic device such that the user can access the first electronic device.

One such method is disclosed in U.S. Pat. No. 6,249,226 to Harrison et al. The method includes attaching identifiers to documents and to users that are moving about a working space. The identifiers emit a signal that is detected by a reader. The reader is connected to a network to allow the document and user access to devices connected to the network. The '226 Patent does not disclose enabling the devices based upon communication with the same access point. The '226 Patent also does not allow the user to move about the working space while maintaining communication with the reader. The user must approach the reader in order for the identifier to be detected.

Another such method is disclosed in U.S. Pat. No. 5,987,062 to Engwer et al. The '062 Patent discloses a wireless local area network that allows roaming of a mobile unit to allow it to serially associate with a number of access points connected to a network. The roaming is supported by a measurement of the communication link quality by calculating a mean error free length of a broadcast by each access point and received by the mobile unit. The measurement of the quality is what determines whether the mobile unit should change to a different access point. However, the '062 Patent does not disclose connecting and authorizing a user to access devices connected to the network based upon the simultaneous communication through the access points.

The related art methods are characterized by one or more inadequacies. The related art methods do not secure the first electronic device and the network from unauthorized users accessing data. The related art methods also require the user to approach the reader in order to activate the first electronic device, thereby limiting the movement of the user about the working space. The related art does not create a secure environment thereby allowing the first electronic device to be enabled when the working space is not secure.

### SUMMARY OF THE INVENTION AND ADVANTAGES

The subject invention provides a method of securing access to a network. The network includes at least one first electronic device and at least one access point. The network is secured from a user having a second electronic device. The method includes the steps of transmitting a radio frequency (RF) signal from the first electronic device and detecting the RF signal from the first electronic device with the access point. The method also includes the steps of transmitting a radio frequency (RF) signal from the second electronic device and detecting the RF signal from the second electronic device with the same access point. The method is characterized by enabling the first electronic device to allow the user having the second electronic device to access the network and the first electronic device in response to the access point detecting the RF signals from both the first and the second electronic devices.

Accordingly, the subject invention overcomes the inadequacies of the related art methods. The subject invention secures the first electronic device and the network from unauthorized users accessing data by requiring the same access point to detect the RF signals. The subject invention also allows the user to move freely about the working space without disabling the first electronic device, while at the same time disabling the first electronic device as soon as the same access point no longer detects both RF signals. These features of the subject invention create a safe and secure networking system for use in varying working environments.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a working environment of a plurality of first electronic devices wirelessly connected to a network and a user moving about the working environment;

FIG. 2 is a perspective view of a working environment of a plurality of first electronic devices connected to a network and a user positioned in a first room;

FIG. 3 is a another perspective view of the working environment of FIG. 2 after the user has moved from the first room to a second room;

FIG. 4 is a exploded view of the user having a second electronic device and an access point for establishing communication between the second electronic device and the access point;

FIG. 5 is a flowchart depicting one of the methods of the subject invention; and

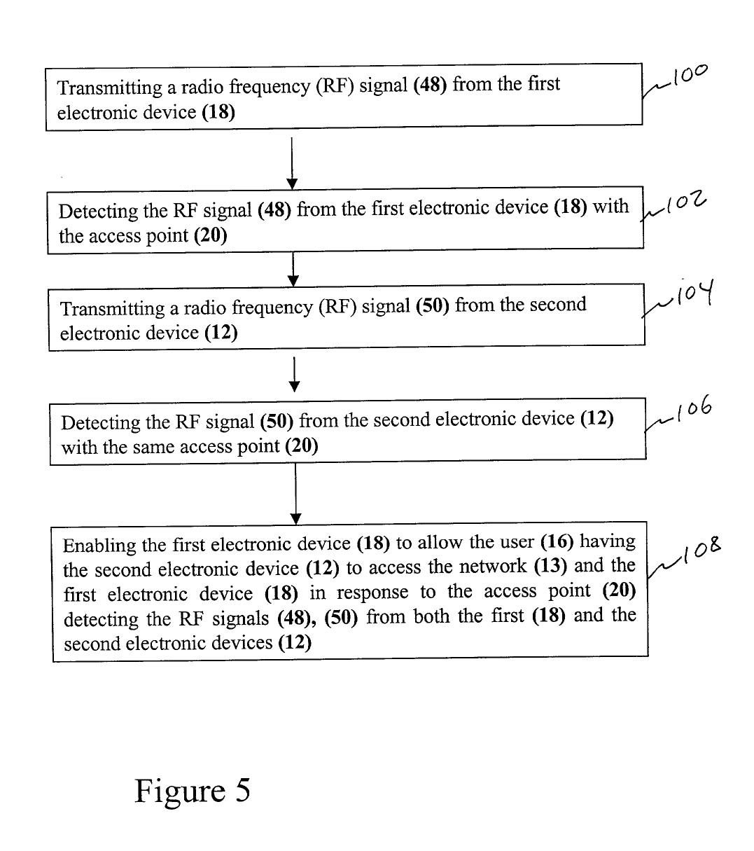

FIG. 6 is a flowchart depicting another method of the subject invention.

### DETAILED DESCRIPTION OF THE PREFERRED EMBODIMENT

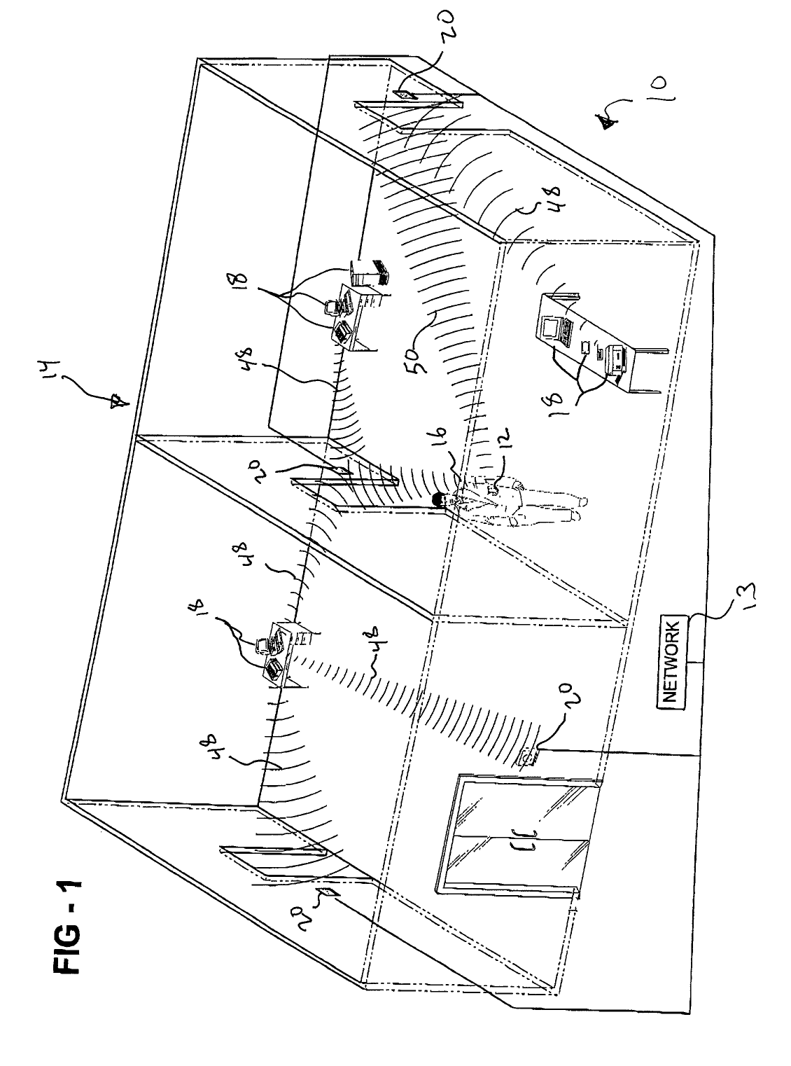

Referring to the Figures, wherein like numerals indicate like or corresponding parts throughout the several views, a method of securing access to a network 13 is disclosed. A system for carrying out the method of the subject invention is illustrated in FIG. 1 at 10. Examples of the system 10 that the subject invention is particularly useful with include piconets and small area networks. The network 13 includes at least one first electronic device 18 and at least one access point 20 and is secured from a user 16 having a second electronic device 12.

The system 10 is disposed within a working space 14 having a predetermined area. The area may include a plurality of buildings, a plurality of rooms, offices, etc. The area preferably has multiple users 16 who move about the working space 14 as illustrated in FIGS. 1-3. As the user 16 moves about the working space 14, a plurality of first electronic devices 18 are positioned about the working space 14 that the user 16 may interact with. A plurality of access points 20 are positioned about the working space 14 and are in communication with the plurality of first electronic devices 18.

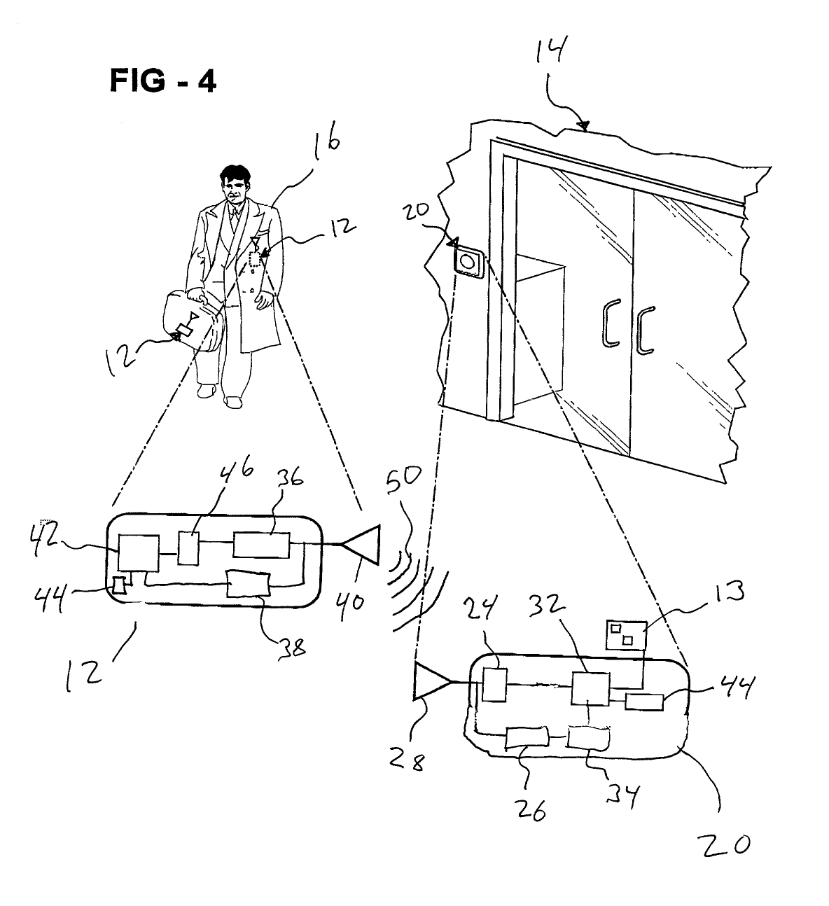

In one embodiment, the access points 20 include a hard link 22 to the network 13. The hard link 22 includes any wired connection as is known in the art. Referring to FIG. 4, the access points 20 also include a transmitter 24, a receiver 26, at least one antenna 28, a power supply 30, and a processor 32 for establishing wireless communication with the first electronic device 18 and the second electronic device 12. The power supply 30 may be connected to the working environment and therefore the access points 20 may not include the power supply 30. The access point 20 may also include a signal strength measurement device 34 for measuring the strength of the wireless signals.

The second electronic device 12, carried by the user 16, includes a transmitter 36, a receiver 38, at least one antenna 40, a processor 42, and a power supply 44. The second electronic device 12 may also include an authorization device 46 to authorize the user 16 to the second electronic device 12. The authorization device 46 may be biometrics, password entry, or any other methods known in the art of identifying a user 16. The second electronic device 12 may be a token, a card, a badge, or other identification carried by the user 16 to verify his identity.

The plurality of first electronic devices 18 includes a processor and a transceiver having a transmitter, a receiver, and at least one antenna. The first electronic device 18 circuitry is similar to that illustrated in FIG. 4 for the second electronic device 12, and therefore is not illustrated. The first electronic device 18 communicates by transmitting radio frequency (RF) signals 48 to the access points 20. The first electronic devices 18 may also include a signal strength measurement device for measuring the strength of RF signals. The first electronic devices 18 may include computers, printers, PDA's, copy machines, cellular phones, or other electronic device found in a working space 14.

Referring to FIG. 1, the method includes the steps of transmitting a RF signal 48 from the first electronic device 18 and detecting the RF signal 48 from the first electronic device 18 with the access point 20, in steps 100 and 102. The same RF signal 48 may be detected by multiple access points 20. The first electronic device 18 is preferably within the predetermined area when transmitting the RF signal 48. The first electronic device 18 may transmit the RF signal 48 at predetermined intervals or may respond to requests from the access point 20 to transmit the RF signal 48. The access point 20 would transmit a response signal to the first electronic device 18, the first electronic device 18 receives the response signal, and then would transmit the requested response to the access point 20.

The method also includes transmitting a radio frequency signal 50 from the second electronic device 12 and detecting the RF signal 50 from the second electronic device 12 with the same access point 20, in steps 104 and 106. The user 16 with the second electronic device 12 is preferably within the predetermined area when transmitting the RF signal 50. The second electronic device 12 may transmit the RF signal 50 at predetermined intervals or may respond to requests from the access point 20 to transmit the RF signal 50. The access point 20 would transmit a response signal to the second electronic device 12, the second electronic device 12 receives the response signal, and then would transmit the requested response to the access point 20.

The method is characterized by enabling the first electronic device 18 to allow the user 16 having the second electronic device 12 to access the network 13 and the first electronic device 18 in response to the access point 20 detecting the RF signals 48, 50 from both the first and the second electronic devices 12, in step 108. When the user 16 enters the predetermined area where the first electronic device 18 is located, both the first electronic device 18 and the second electronic device 12 are communicating with the same access point 20. The access point 20 receives both the first electronic device 18 and the second electronic device 12 RF signals 48, 50 and allows the user 16 to operate the first electronic device 18 since both RF signals 48, 50 are received by the same access point 20. The access point 20 then transmits an authorized signal to the first electronic device 18 thereby enabling the first electronic device 18 such that the user 16 can access the first electronic device 18. For example, in FIG. 1, the user 16 can access all of the first electronic devices 18. Half through one access point 20 and the other half through the other access point 20.

The RF signals 50 from the second electronic device 12 may also include user information which the access point 20 may then utilize when enabling the first electronic device 18. The access point 20 receives the user information from the second electronic device 12 and compares the user information to a user database on the network 13. The user database stores user privileges such that the access point 20 only allows the user 16 access to certain portions of the network 13 listed as the user privilege.

The method further includes steps of measuring a signal strength for the RF signal 48, 50 from both the first and the second electronic devices 12. The access point 20, after receiving the RF signal 48, 50 from either of the first and the second electronic device 12, measures the signal strength and compares the signal strengths to a predetermined threshold. The predetermined threshold may be altered for different level of securities or different predetermined areas. For example, if an area has more than one access point, the predetermined threshold may be set high such that even though many access points 20 are receiving the RF signals 48, 50, very few access points 20 are measuring the signal strengths above the predetermined threshold. The access point 20 enables the first electronic device 18 in response to both of the signal strengths being above the predetermined threshold.

The signal strength measurement may be made by measuring the RF signal 48, 50 strength transmitted by each of the first 18 and the second electronic devices 12. The signal strength measurement may also be measured by utilizing more than one antenna and detecting the same RF signal 48, 50 with each of the antennas and determining the maximum signal strength. The signal strength measurement may also be determined from multiple signals from each of the devices and then determining an overall signal strength from the multiple signals for each of the first and the second devices. It is to be understood that the signal strength may be measured by any other methods known in the art of RF signal strength measurement.

The first electronic device 18 is disabled in response to either one of the signal strengths from the first electronic device 18 and the second electronic devices 12 being measured below the predetermined threshold by the access point 20. As the user 16 moves about the predetermined threshold, the RF signal 50 strength from the second electronic device 12 will change with the location to the access point 20. When the user 16 moves far away from the access point 20, the RF signal 50 strength from the second electronic device 12 falls below the predetermined threshold. The access point 20 transmits a disabling signal to the first electronic and disables the first electronic device 18 upon receiving the disabling signal.

After the first electronic device 18 has been enabled, the access point 20 may become a routing point for all data that is transmitted between the first 18 and the second electronic device 12. Either one of the first 18 and the second electronic devices 12 may transmit data to the access point 20, the access point 20 receives the data and then routes the data from the access point 20 to the other electronic device. For example, the first electronic device 18 may have a security setting which requires the signal strength to be measured at different intervals than the access point 20. The first electronic device 18 transmits a request for the second electronic device 12 to send a measurement signal and for the access point 20 to measure the signal strength. The access point 20 receives the request and transmits it to the second electronic device 12. The second electronic device 12 receives the request and transmits the measurement signal. The access point 20 receives the measurement signal and measures the signal strength. The access point 20 then transmits the signal strength to the first electronic device 18.

Alternately, after the access point 20 has enabled the first electronic device 18, the access point 20 may instruct the first 18 and the second electronic devices 12 to communicate directly with one another, thereby bypassing the access point 20. The access point 20 may also transmit timing intervals to either one of the first 18 and the second electronic devices 12 such that the electronic device is activated during the timing intervals to detect the signal from the other electronic device. The access point 20 may receive timing interval information from the second electronic device 12 as to when the second electronic device 12 will be transmitting signals. The access point 20 then transmits the timing interval to the first electronic device 18. The first electronic device 18 will then activate during those time intervals to detect the signals from the second electronic device 12. By only activating the first electronic device 18 when the second electronic device 12 is transmitting, the power consumption and the unauthorized detection of the transmitted signals is reduced. The timing interval information may also include transmission information, such as frequency and duration of the signal, so that the first electronic device 18 will know the frequency to receive the signal.

With multiple access points 20, more than one access point 20 may be detecting the RF signals 48, 50 from the first 18 and the second electronic devices 12. If the RF signal 48, 50 strengths fall below the predetermined threshold at one access point 20, a different access point 20 may also measure the RF signal 48, 50 strengths above the predetermined threshold. If the different access point 20 measures the signal strengths above the predetermined threshold, the first electronic device 18 may be re-enabled in response to the RF signals 48, 50 from the first 18 and the second electronic device 12 being above the predetermined threshold at the different access point 20. If at least one access point 20 is measuring the RF signal 50 from the second electronic device 12 as being above the predetermined threshold, the user 16 data may be loaded into all other access points 20. The synchronizing of the user 16 data from the different access points 20 to the first electronic device 18 is in response to the RF signal 50 strength from the second electronic device 12 being above the predetermined threshold at the different access point 20. Since the user 16 is able to move about the predetermined area, the RF signal 50 from the second electronic device 12 may be continuously detected by the other access points 20. If the RF signal 50 from the second electronic device 12 falls below the predetermined threshold at one access point 20, but remains above the predetermined threshold at the different access point 20, the first electronic device 18 and the network 13 remain enabled. By loading the user data into the other access points 20, the first electronic device 18 and the network 13 may switch to the different access point 20 without disabling the first electronic device 18.

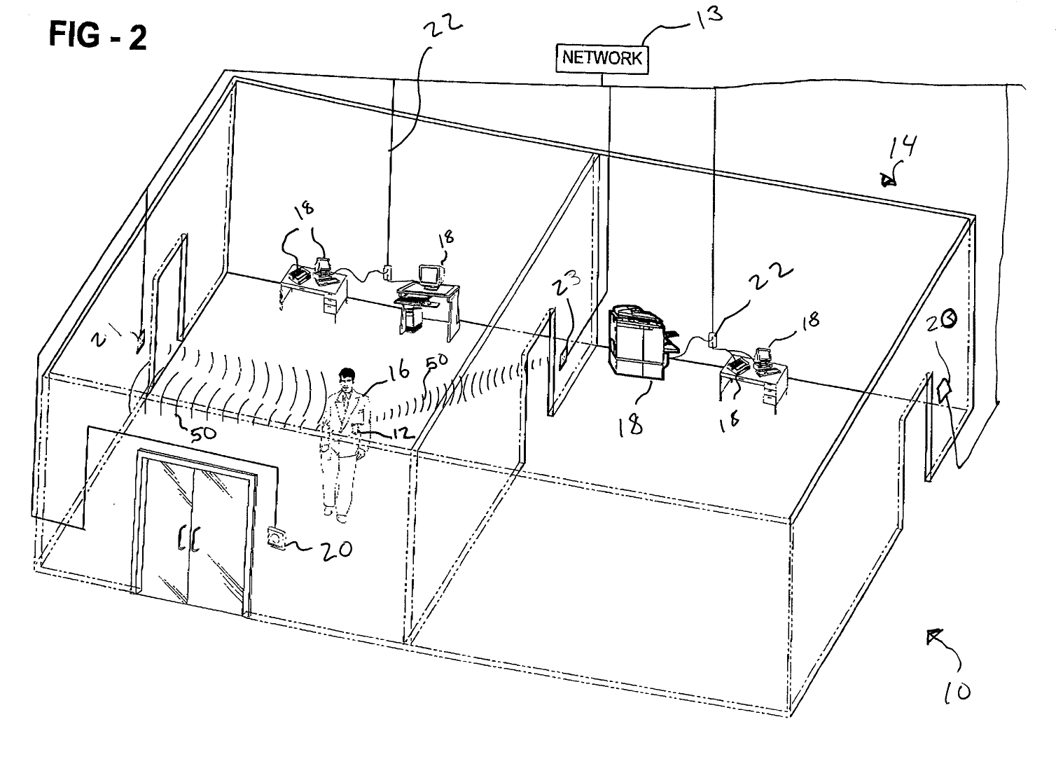

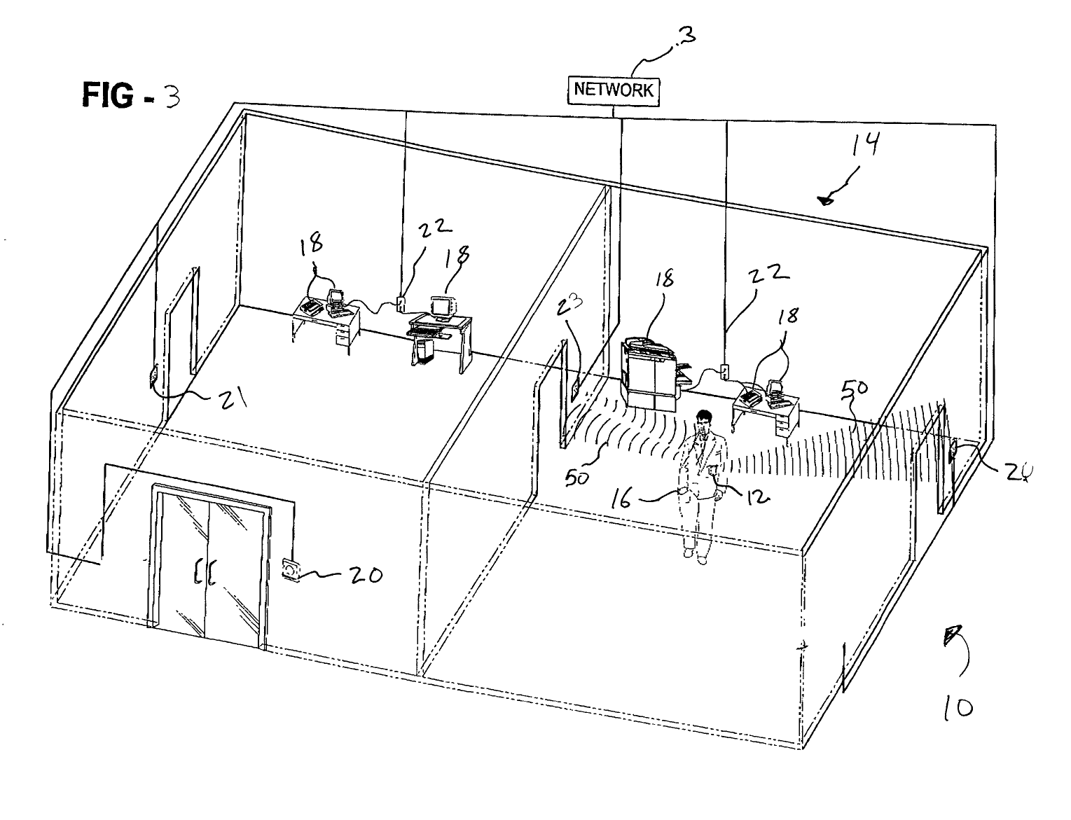

In another embodiment of the subject invention, referring to FIGS. 2 and 3, the first electronic device 18 is connected to the network 13 via a hardwired link 52. The hardwire link 52 may be either a serial, parallel, or USB cable that extends from the network 13. The first electronic device 18 includes a card or similar device for receiving the hardwire link and thereby establishing a connection to the network 13. The system 10 includes a plurality of first electronic device 18 connected to the network 13 through these hardwire links 50. The access points 20 and the second electronic device 12 include the same components as described above.

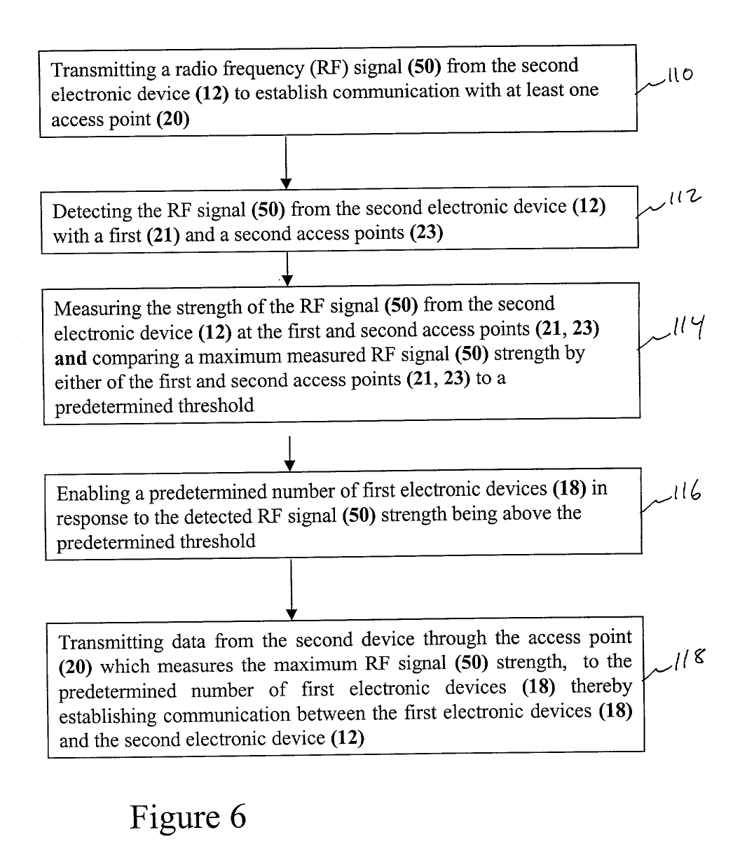

This embodiment provides a method of securing access to the network 13, as depicted in FIG. 6. The method includes the steps of transmitting the RF signal 50 from the second electronic device 12 to establish communication with at least one access point 20, in step 110, and detecting the RF signal 50 from the second electronic device 12 with a first and a second access points 21, 23, in step 112. The first and second access points 21, 23 measure the strength of the RF signal 50 from the second electronic device 12 and compare a maximum measured RF signal 50 strength by either of the first and second access points 21, 23 to a predetermined threshold, in step 114. In step 116, a predetermined number of first electronic devices 18 are enabled in response to the detected RF signal 50 strength being above the predetermined threshold at either of the first and second access points 21, 23. The predetermined number of first electronic devices 18 include the first electronic devices 18 positioned relative to one another. For example, one room may have a computer, a printer, and a cellular phone. When the second electronic device 12 establishes communication with the access point 20 in the room, the user 16 is authorized to use any the devices.

The method is characterized by transmitting data, in step 118, from the second electronic device 12 through the access point 20 which measures the maximum RF signal 50 strength, to the predetermined number of first electronic devices 18 thereby establishing communication between the first electronic devices 18 and the second electronic device 12. If the second access point 23 measures the maximum signal strength, the second electronic device 12 establishes communication with the second access point 23 to transmit data to the first electronic devices 18. While communicating with the second access point 23, the first access point 21 continues to measure the RF signal 50 strength, such that if the first access point 21 measures the stronger RF signal 50 strength, the second electronic device 12 will establish communication through the first access point 21.

As both the first and second access points 21, 23 receive the RF signal 50, the user 16 data is loaded into the first and second access points 21, 23. Therefore, as the user 16 moves about the predetermined area and the signal strength becomes stronger at the first access point 21 than the second access point 23, the first electronic devices 18 remain enabled as soon as communication is established with the first access point 21 because the user 16 data is already loaded into the other access point 20.

The method further includes transferring communication to one of the first and second access points 21, 23 in response to the RF signal 50 strength at the other access point 20 falling below the predetermined threshold. The first electronic devices 18 are disabled in response to the RF signal 50 strength from the second electronic device 12 being measured below the predetermined threshold at both the first and second access points 21, 23. After the RF signal 50 strength is measured below the predetermined threshold at each access point 20, the user data is removed from the first and second access points 21, 23.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A method of securing access to a network (13), the network (13) including at least one first electronic device (18) and at least one access point (20), from a user (16) having a second electronic device (12), said method comprising the steps of:
transmitting a radio frequency (RF) signal (48) from the first electronic device (18);
detecting the RF signal (48) from the first electronic device (18) with the access point (20);
transmitting a radio frequency (RF) signal (50) from the second electronic device (12);
detecting the RF signal (50) from the second electronic device (12) with the same access point (20);
said method characterized by enabling the first electronic device (18) to allow the user (16) having the second electronic device (12) to access the network (13) and the first electronic device (18) in response to the access point (20) detecting the RF signals (48, 50) from both the first (18) and the second electronic devices (12).

2. A method as set forth in claim 1 further including the steps of measuring a signal strength for the RF signal (48, 50) from both the first (18) and the second electronic devices (12), comparing the signal (48, 50) strengths to a predetermined threshold, and enabling the first electronic device (18) in response to both of the signal strengths being above the predetermined threshold.

3. A method as set forth in claim 2 further including the step of disabling the first electronic device (18) in response to either one of the signal (48, 50) strengths from the first electronic device (18) and the second electronic devices (12) being measured below the predetermined threshold by the access point (20).

4. A method as set forth in claim 2 further including the step of transmitting data from either one of the first (18) and the second electronic devices (12) to the access point (20) and routing data from the access point (20) to the other electronic device.

5. A method as set forth in claim 2 further including the step of activating either one of the first (18) and the second electronic device (12) to transmit the data directly to the other in response to instructions from the access point (20) thereby bypassing the access point (20).

6. A method as set forth in claim 5 wherein the step of activating either one is further defined as transmitting timing intervals from the access point (20) to either one of the first (18) and the second electronic devices (12) and activating the one during the timing intervals to detect the other.

7. A method as set forth in claim 3 further including the steps of detecting the RF signals (48, 50) from the first (18) and the second electronic devices (12) by a different access point (20), measuring the RF signal (48, 50) strengths at the different access point (20), and re-enabling the first electronic device (18) in response to the RF signals (48, 50) from the first (18) and the second electronic device (12) being above the predetermined threshold.

8. A method as set forth in claim 7 further including the step of loading user data into each of the access points (20) in response to at least one access point (20) measuring the RF signal (50) from the second electronic device (12) as being above the predetermined threshold.

9. A method as set forth in claim 8 further including the step of synchronizing the user data from the different access points (20) to the first electronic device (18) in response the RF signal (50) from the second electronic device (12) being above the predetermined threshold at the different access point (20).

10. A method of securing access to a network (13), the network (13) including at least one first electronic device (18) and at least one access point (20), from a user (16) having a second electronic device (12), said method comprising the steps of:
transmitting a radio frequency (RF) signal (50) from the second electronic device (12) to establish communication with at least one access point (20);
detecting the RF signal (50) from the second electronic device (12) with a first (21) and a second access points (23);
measuring the strength of the RF signal (50) from the second electronic device (12) at the first and second access points (21, 23);
comparing a maximum measured RF signal (50) strength by either of the first and second access points (21, 23) to a predetermined threshold;
enabling a predetermined number of first electronic devices (18) in response to the detected RF signal (50) strength being above the predetermined threshold;
said method characterized by transmitting data from the second device through the access point (20) which measures the maximum RF signal (50) strength, to the predetermined number of first electronic devices (18) thereby establishing communication between the first electronic devices (18) and the second electronic device (12).

11. A method as set forth in claim 10 further including the step of loading user data into the first and the second access points (21, 23) in response to the RF signal (50) from the second electronic device (12) being above the predetermined threshold at either of the first and the second access points (21, 23).

12. A method as set forth in claim 1 1 further including the step of transferring communication to one of the first and second access points (21, 23) in response to the RF signal (50) strength at the other access point falling below the predetermined threshold.

13. A method as set forth in claim 12 further including the step of disabling the first electronic devices (18) in response to the RF signal (50) strength from the second electronic device (12) being measured below the predetermined threshold at both the first and second access points (21, 23).

14. A method as set forth in claim 13 further including the step of removing the user data from the first and the second access points (21, 23) in response to the RF signal (50) strength falling below the predetermined threshold at the first and second access points (21, 23).
